(19) United States
(12) Patent Application Publication
(10) Pub. No.: US 2025/0126123 A1
(43) Pub. Date: Apr. 17, 2025

(54) MULTI-PERSONA RESOURCE ACCESS AND COLLABORATION WITH FINE-GRAINED ACCESS CONTROLS

(71) Applicant: Capital One Services, LLC, McLean, VA (US)

(72) Inventor: Pedro BETANCOURT, McKinney, TX (US)

(21) Appl. No.: 18/485,946

(22) Filed: Oct. 12, 2023

(51) Int. Cl. H04L 9/40

(52) U.S. Cl. CPC H04L 63/101; H04L 63/102; H04L 63/105

(57) ABSTRACT

In some implementations, a collaboration system may receive, from a first client device, a first request to create a software domain resource associated with a consumer persona type and a service consumer user identity, wherein the software domain resource is associated with access control information that indicates one or more service provider user identities, associated with a provider persona type, that have permission to access the software domain resource. The collaboration system may receive, from a second client device associated with a service provider user identity, a second request to access the software domain resource. The collaboration system may provide, to the second client device, information that indicates whether the second request to access the software domain resource is granted or rejected based on the access control information associated with the software domain resource and the service provider user identity associated with the second client device.

### BACKGROUND

Collaboration systems, also known as collaborative software, collaboration tools, groupware, or the like, are digital tools and platforms designed to facilitate communication, coordination, and cooperation among individual users or groups of users working together, often remotely. Collaboration systems generally encompass various technologies and features to support collaborative work processes. For example, collaboration systems often provide communication tools to support collaborative work processes, where various communication channels (e.g., text-based messaging, voice calls, video conferencing, or the like) enable real-time and/or asynchronous communication in which users interact in ways to suit their needs. In addition, collaboration systems may support document sharing and management (e.g., providing a centralized location for storing, sharing, and managing documents and files), collaborative editing (e.g., where different users can simultaneously work on the same file and changes are synchronized instantly), and/or security and access controls (e.g., verifying that users have appropriate permissions to access and/or modify shared resources), among other examples.

### SUMMARY

Some implementations described herein relate to a system for multi-persona resource access and collaboration. The system may include one or more memories and one or more processors communicatively coupled to the one or more memories. The one or more processors may be configured to receive, from a first client device, a first request to create a software domain resource associated with a consumer persona type and a service consumer user identity. The one or more processors may be configured to receive, from the first client device, a second request to share the software domain resource with one or more service provider user identities associated with a provider persona type. The one or more processors may be configured to store access control information associated with the software domain resource, wherein the access control information indicates that the one or more service provider user identities associated with the second request have permission to access the software domain resource. The one or more processors may be configured to receive, from a second client device associated with a service provider user identity, a third request to access the software domain resource. The one or more processors may be configured to provide, to the second client device, information that indicates whether the third request to access the software domain resource is granted or rejected based on the access control information associated with the software domain resource and the service provider user identity associated with the second client device.

Some implementations described herein relate to a method for multi-persona resource access and collaboration. The method may include receiving, by a collaboration system and from a first client device, a first request to create a software domain resource associated with a consumer persona type and a service consumer user identity, wherein the software domain resource is associated with access control information that indicates one or more service provider user identities, associated with a provider persona type, that have permission to access the software domain resource. The method may include receiving, by a collaboration system and from a second client device associated with a service provider user identity, a second request to access the software domain resource. The method may include providing, by the collaboration system and to the second client device, information that indicates whether the second request to access the software domain resource is granted or rejected based on the access control information associated with the software domain resource and the service provider user identity associated with the second client device.

Some implementations described herein relate to a non-transitory computer-readable medium that stores a set of instructions. The set of instructions, when executed by one or more processors of a collaboration system, may cause the collaboration system to receive, from a first client device, a first request to create a software domain resource associated with a consumer persona type and a service consumer user identity. The set of instructions, when executed by one or more processors of the collaboration system, may cause the collaboration system to receive, from the first client device, a second request to share the software domain resource with one or more service provider user identities associated with a provider persona type. The set of instructions, when executed by one or more processors of the collaboration system, may cause the collaboration system to store access control information associated with the software domain resource, wherein the access control information indicates that the one or more service provider user identities associated with the second request have permission to access the software domain resource. The set of instructions, when executed by one or more processors of the collaboration system, may cause the collaboration system to receive, from a second client device associated with a service provider user identity, a third request to access the software domain resource. The set of instructions, when executed by one or more processors of the collaboration system, may cause the collaboration system to provide, to the second client device, information that indicates whether the third request to access the software domain resource is granted or rejected based on the access control information associated with the software domain resource and the service provider user identity associated with the second client device.

### BRIEF DESCRIPTION OF THE DRAWINGS

FIGS. 1A-1C are diagrams of an example associated with multi-persona resource access and collaboration with fine-grained access controls, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of one or more devices of FIG. 2, in accordance with some embodiments of the present disclosure.

FIG. 4 is a flowchart of an example process associated with multi-persona resource access and collaboration with fine-grained access controls, in accordance with some embodiments of the present disclosure.

### DETAILED DESCRIPTION

The following detailed description of example implementations refers to the accompanying drawings. The same reference numbers in different drawings may identify the same or similar elements.

Access controls in collaboration systems have an important role in managing and securing access to and the sharing of information and resources among different users. Access controls may be defined in various ways to ensure that only authorized users or entities have appropriate access to data and functionalities within a collaboration system. For example, in some cases, a collaboration system may support role-based access controls (e.g., where roles are assigned to users and each role has specific permissions and access rights), user authentication (e.g., where a username and password, multi-factor authentication, and/or biometrics are used to verify the identity of a user), access control lists (e.g., defining which users can access specific resources and/or what actions the users can perform), and/or single sign-on (SSO) techniques that enable users to access multiple collaboration tools or platforms with a single set of credentials, among other examples. However, one challenge that may arise in a collaboration system is to configure access controls that allow users associated with different personas (or persona types) to create, share, interact with, and/or otherwise collaborate on resources associated with a particular software domain. For example, a collaboration system related to a particular service may be accessed by a first set of users associated with a first persona type, a second set of users associated with a second persona type, and/or other sets of users associated with other persona types, where each persona type may be defined within a data structure or an object based on information that represents a specific group of users that share certain attributes, such as demographic information, psychographic details, and/or user-related scenarios. However, collaboration systems generally lack support for access control techniques to control and enforce permissions to access, modify, or interact with software domain resources in accordance with the attributes shared among users associated with certain persona types.

In some implementations, as described herein, a collaboration system may enable users associated with different persona types to create and share software domain resources such that users with the different persona types can collaborate in a given application context (or business domain). For example, in some implementations, the collaboration system may include or may be associated with a resource repository that stores various software domain resources associated with a particular business domain that serves users associated with different persona types, and the collaboration system may enable collaboration on the software domain resources by users associated with the different persona types using fine-grained access controls and different levels of resource aggregation. For example, as described herein, the collaboration system may be associated with a business domain or other service context (e.g., vehicle sales and/or financing, travel, healthcare, and/or insurance, among other examples), where users associated with a service consumer persona type may create software domain resources (e.g., modeled vehicle loans, loan pre-qualifications, modeled travel itineraries, insurance quotes, or the like) that are associated their user identities, and the users associated with the service consumer persona type may be provided with an option to share any appropriate combination of their software domain resources with users associated with a service provider consumer type. In a similar manner, users associated with the service provider persona type may create software domain resources that are associated their user identities (e.g., loan offers, vehicle offers, travel packages, insurance policies, or the like), and the users associated with the service provider persona type may optionally share any appropriate combination of their software domain resources with users associated with the service consumer type.

Accordingly, in some implementations, the collaboration system may maintain configurable client (or user) information in which each user may be classified or otherwise associated with a persona type (e.g., a service consumer or service provider in some examples described herein), where the client (or user) information indicates which persona types and/or user identities are permitted to access or collaborate on software domain resources shared by other users. Furthermore, in some implementations, the client (or user) information may define an aggregation level for one or more persona types to control which resources are accessible by users associated with the one or more persona types. For example, users associated with the (service) consumer persona type may be permitted to access all global software domain resources that are related to them across all users associated with the service provider persona type. On the other hand, users associated with the (service) provider persona type may be permitted to access only a set of software domain resources that were specifically shared with their user identities, and may be blocked or otherwise restricted from accessing any unshared software domain resources associated with the consumer persona type and/or any software domain resources shared only with other service provider user identities.

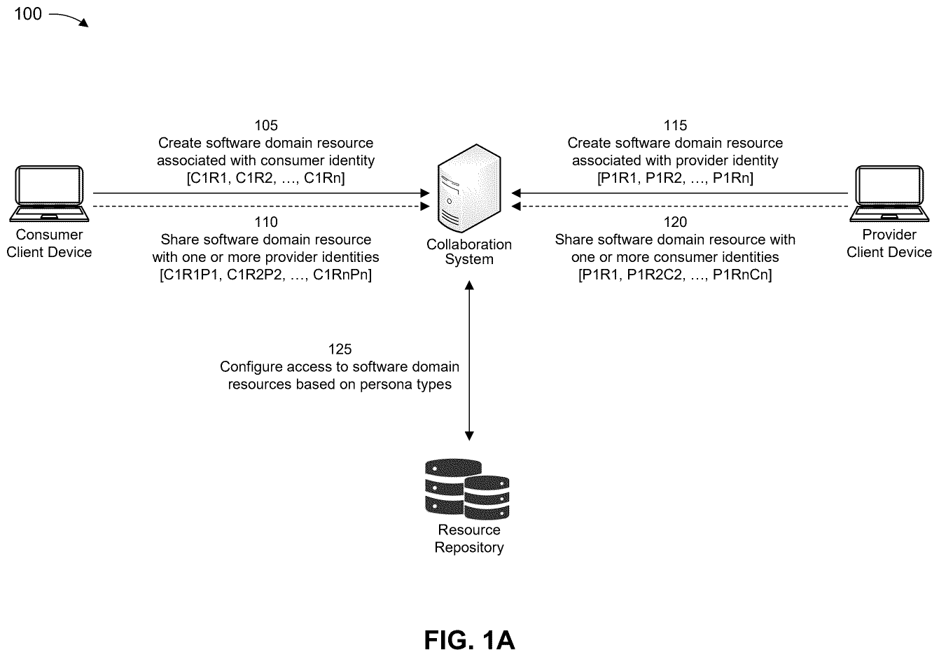

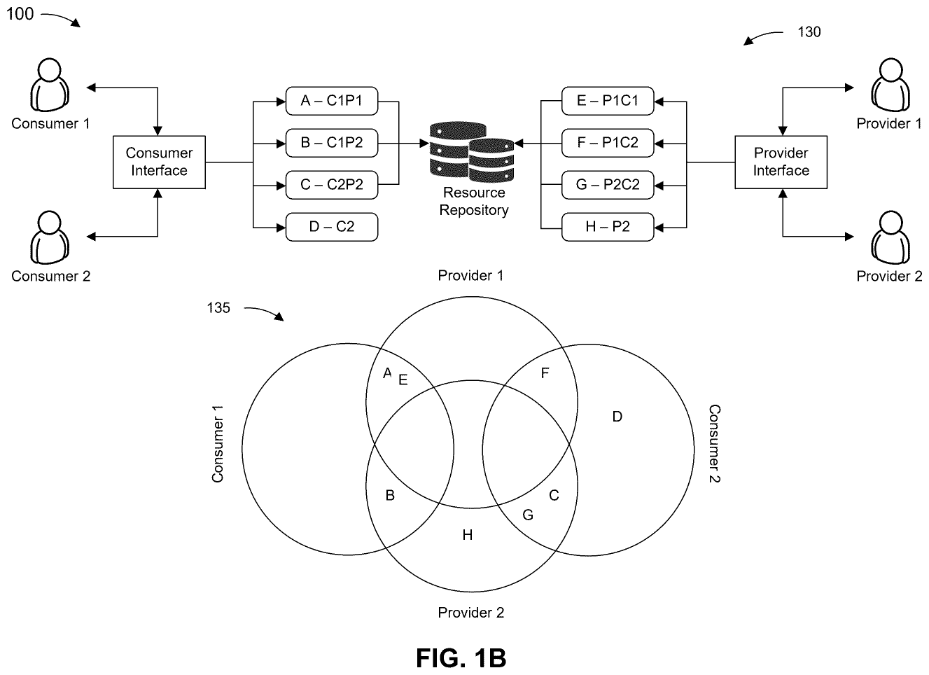

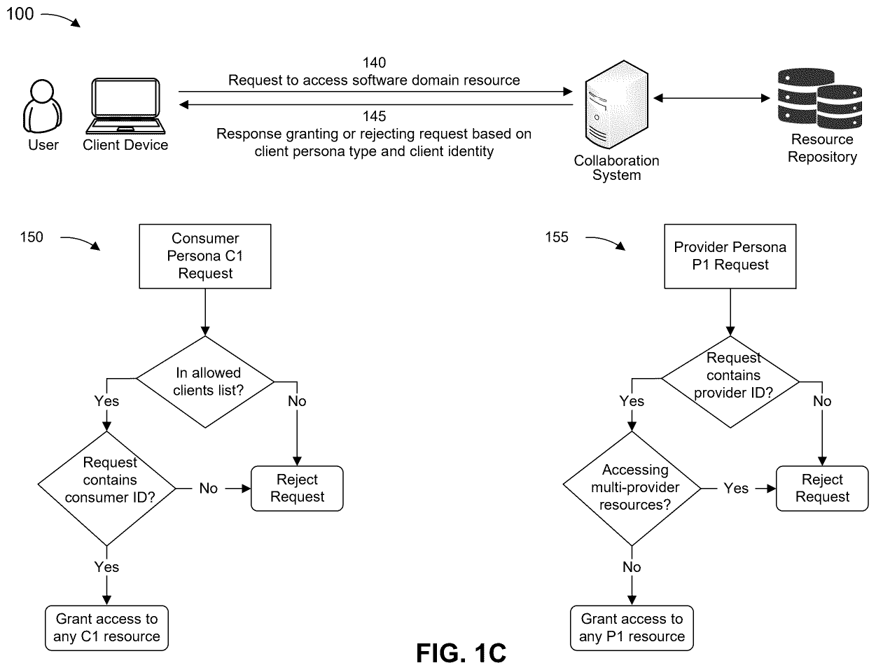

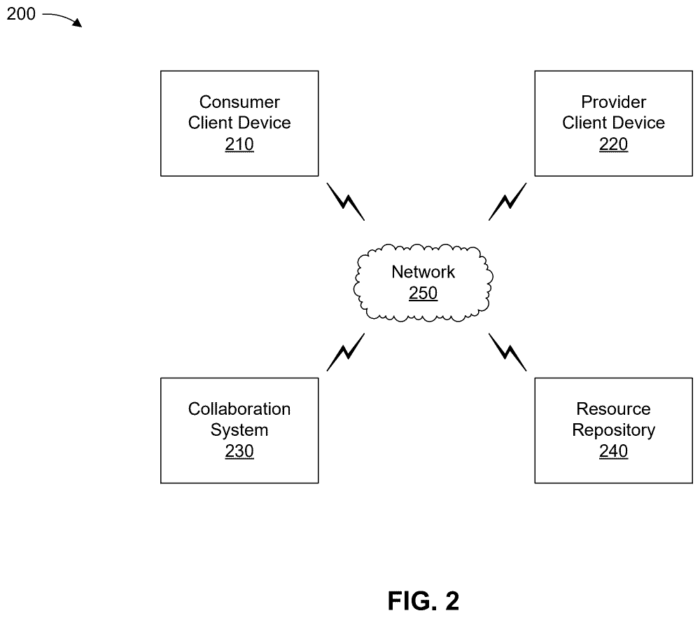

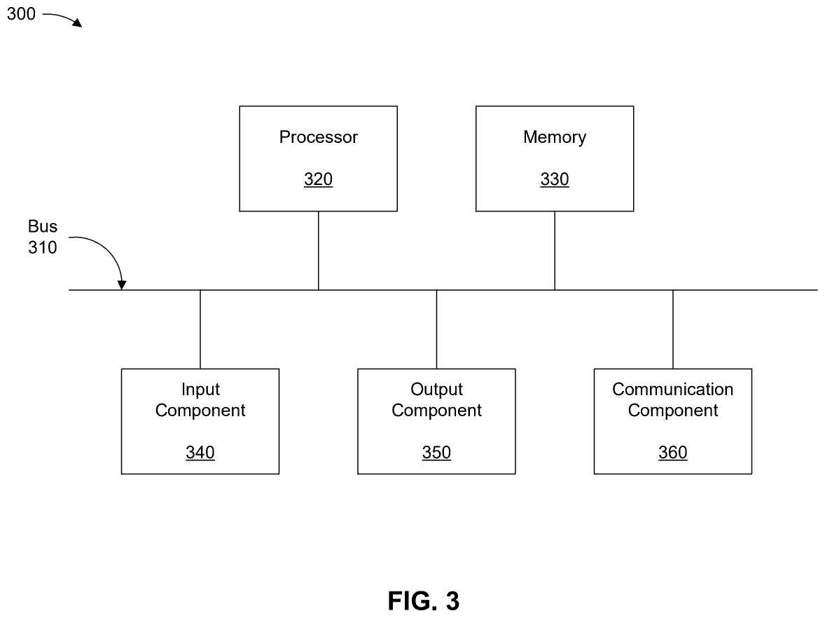

FIGS. 1A-1C are diagrams of an example 100 associated with multi-persona resource access and collaboration with fine-grained access controls. As shown in FIGS. 1A-1C, example 100 includes a consumer client device, a provider client device, a collaboration system, and a resource repository. The consumer client device, the provider client device, the collaboration system, and the resource repository are described in more detail in connection with FIGS. 2-3.

In some implementations, as shown in FIG. 1A and described herein, the collaboration system may enable users associated with different persona types to create and share software domain resources such that users with the different persona types can collaborate in a given application context (or business domain). For example, the resource repository may be configured to store various software domain resources associated with a particular business domain that serves users associated with different persona types, such as service consumer persona type and a service provider persona type. For example, in some implementations, the collaboration system may be associated with a vehicles sales and/or financing service, in which case the service consumer persona type may capture demographic information, psychographic details, user-related scenarios, and/or other attributes associated with users that are potentially interesting in purchasing or financing a vehicle, and the service provider persona type may capture demographic information, psychographic details, user-related scenarios, and/or other attributes associated with users (or entities) that are offering vehicles for sale and/or offering vehicle financing. In other examples, the collaboration system may be provided in a travel booking context (e.g., where users associated with the service consumer persona type may be potential travelers and users associated with the service provider persona type may be travel agents or associated with travel agencies), a healthcare context (e.g., where users associated with the service consumer persona type may be patients and users associated with the service provider persona type may be healthcare providers), and/or other suitable contexts. Accordingly, although some implementations are described herein with respect to a business or application context related to vehicle sales or vehicle financing, some implementations described herein may be applicable to any suitable application context where a service consumer and a service provider may collaborate or share access to software domain resources (e.g., information related to the service context). Furthermore, although some implementations are described herein with respect to a service-related context, where users associated with service consumer and service provider persona types collaborate on shared software domain resources, it will be appreciated that some implementations described herein may be applied to any suitable persona type(s).

As shown in FIG. 1A, and by reference number 105, the collaboration system may receive, from a consumer client device (e.g., a client device operated by a user associated with a consumer persona type), a request to create one or more software domain resources associated with a consumer identity (e.g., an identity associated with the user operating the consumer client device). For example, in some implementations, the consumer client device may be used to access the collaboration system in a vehicle sales context, and the collaboration system may provide one or more tools, microservices, utilities, or other functions that users associated with the consumer identity can use to conduct research, planning, modeling, or other tasks related to a potential vehicle purchase. For example, the collaboration system may provide or may be associated with a vehicle sales platform that provides a tool, microservice, utility, or function to estimate monthly payments for a vehicle or perform basic calculation capabilities to initiate vehicle deal building (e.g., based on a credit score, a down payment, a term length, an interest rate, a trade-in value, a total financing amount, and/or other parameters, which may be input by the user of the consumer client device or obtained from one or more third parties). In another example, the vehicle sales platform may provide a pre-qualification tool that provides vehicle deal building capabilities with financing recalculation capabilities, policy guidance, and/or alternative financing offers in a context related to pre-qualifying for vehicle financing. For example, the user of the consumer client device may provide a request that indicates whether the user is pursuing pre-qualification for a vehicle purchase or a lease, an estimated down payment, a term length, and/or other parameters, and the vehicle sales platform may provide one or more financing options (e.g., offering different terms, interest rates, and/or monthly payments that are available through one or more lenders or financial institutions).

Accordingly, in cases where the collaboration system is associated with a vehicle sales platform, the one or more software domain resources created by the user of the consumer client device may include one or more data structures, objects, and/or other resources that capture the information that is modeled by the user of the consumer client device (e.g., estimated payment calculations for one or more vehicles, a pre-qualification status, a vehicle configuration including a make, model, trim level, and/or other attributes, or the like). Alternatively, in a travel booking context, the collaboration system may provide tools, utilities, microservices, or other functions for planning flight or other transportation, hotel reservations or other accommodations, car rentals, or the like, in which case the one or more software domain resources created by the user of the consumer client device may include one or more data structures, objects, and/or other resources that capture the travel-related information modeled by the user of the consumer client device. Furthermore, it will be appreciated that the software domain resource(s) created by the user of the consumer client device may vary for contexts related to other suitable services.

In some implementations, as described herein, the user of the consumer client device may be associated with a consumer persona type, and a service consumer user identity may be used to uniquely identify the user associated with the consumer persona type. Accordingly, when the user of the consumer client device interacts with the collaboration system to create the one or more software domain resources, each software domain resource may be associated with the service consumer user identity of the user operating the consumer client device. For example, as shown in FIG. 1A, a first service consumer user identity associated with a first user operating a first consumer client device may be represented as C1, and each software domain resource created by the first user may be associated with the first service consumer user identity. For example, the first user of the first consumer client device may create a set of n software domain resources, which may be represented as [C1R1, C1R2, . . . , C1Rn]. In a similar respect, a second service consumer user identity associated with a second user operating a second consumer client device may create a set of n software domain resources, which may be represented as [C2R1, C2R2, . . . , C2Rn], a third service consumer user identity associated with, a third user operating a third consumer client device may create a set of n software domain resources, which may be represented as [C3R1, C3R2, . . . , C3Rn], and so on. Accordingly, the collaboration system may generally allow various consumer client devices to create one or more software domain resources, each of which may be associated with a respective service consumer identity. The representation described herein for the software domain resources is illustrative only, and any suitable attributes, data structures, lists, or other information may be used to represent the relationship between a software domain resource and a service consumer user identity of a user associated with a consumer persona type.

As further shown in FIG. 1A, and by reference number 110, the user of the consumer client device may interact with the collaboration system to share one or more software domain resources with one or more service provider user identities, which are associated with a service provider persona type. For example, in some implementations, the collaboration system may be associated with a vehicle sales platform in which one or more estimated payment calculations, financing pre-qualification, vehicle configurations, or the like may be shared with one or more vehicle dealers that offer vehicles for sale, one or more financial institutions that offer vehicle financing, or the like. In another example, the collaboration system may be associated with a travel booking platform in which one or more flight itineraries, hotel reservations, car rentals, or the like may be shared with one or more travel agencies, airlines, hotels, car rental agencies, or the like. For example, in some implementations, the tools, utilities, microservices, or other functions that are provided by or facilitated through the collaboration system may include one or more options to share the software domain resources with one or more service provider user identities that are associated with the service provider persona type (e.g., a button or option may be selected by the user of the consumer client device to send a pre-qualification status or an estimated payment calculation to a vehicle dealer and thereby share the corresponding software domain resource). For example, a first user associated with a first service consumer user identity (C1) may share a first software domain resource (R1) with a first service provider (P1), whereby the sharing information associated with the first software domain resource may be represented as C1R1P1. Similarly, the first user may share a second software domain resource (R2) with a second service provider (P2) and an nth software domain resource (Rn) with an nth service provider (Pn), whereby the sharing information associated with n software domain resources created by the first user may be represented as [C1R1P1, C1R2P2, . . . , C1RnPn].

As further shown in FIG. 1A, and by reference number 115, the collaboration system may receive, from a provider client device (e.g., a client device operated by a user associated with a service provider persona type), a request to create one or more software domain resources associated with a service provider user identity. For example, in cases where the provider client device is used to access the collaboration system in a vehicle sales context, the collaboration system may provide one or more tools, microservices, utilities, or other functions that users associated with the service provider user identity can use to construct vehicle deals, financing offers, incentive packages, or other suitable information related to a potential vehicle purchase. In another example, in a travel booking context, the collaboration system may provide tools, utilities, microservices, or other functions for offering available flights or other transportation, hotel reservations or other accommodations, car rentals, or the like to tourists or other travelers, in which case the one or more software domain resources created by the user of the consumer client device may include one or more data structures, objects, and/or other resources that capture the travel-related information modeled by the user of the provider client device. Furthermore, it will be appreciated that the software domain resource(s) created by the user of the provider client device may vary for contexts related to other suitable services.

Accordingly, in cases where the collaboration system is associated with a vehicle sales platform, the one or more software domain resources created by the user of the provider client device may include one or more data structures, objects, and/or other resources that capture the information that is modeled by the user of the provider client device. For example, as described herein, the provider client device may be a terminal or other suitable device associated with a service provider user identity, which may be associated with a service provider persona type that captures various attributes shared by a group of users that correspond to a service provider for a particular context. Accordingly, when the user of the provider client device interacts with the collaboration system to create the one or more software domain resources, each software domain resource may be associated with the service provider user identity associated with the provider client device. For example, as shown in FIG. 1A, a first service provider user identity associated with a first provider client device may be represented as P1, and each software domain resource created by the first service provider user identity may be associated with the first service provider user identity. For example, the first provider client device may be used to create a set of n software domain resources, which may be represented as [P1R1, P1R2, . . . , P1Rn]. In a similar respect, a second provider client device associated with a second service provider user identity may create a set of n software domain resources, which may be represented as [P2R1, P2R2, . . . , P2Rn], a third provider client device associated with a third service provider user identity may create a set of n software domain resources, which may be represented as [P3R1, P3R2, . . . , P3Rn], and so on. Accordingly, the collaboration system may generally allow various provider client devices to create one or more software domain resources, each of which may be associated with a respective service provider user identity. However, as described herein, the representation for the software domain resources is illustrative only, and any suitable attributes, data structures, lists, or other information may be used to represent the relationship between a software domain resource and a service provider user identity associated with a service provider persona type.

As further shown in FIG. 1A, and by reference number 120, the user of the provider client device may interact with the collaboration system to share one or more software domain resources with one or more service consumer user identities, which are associated with a service consumer persona type. For example, when the collaboration system is associated with a vehicle sales platform, the shared software domain resources may include vehicle deals, financing offers, incentive packages, and/or other information related to a potential vehicle purchase or lease, which may be globally shared with all users associated with the service consumer persona type. In another example, when the collaboration system is associated with a travel booking platform, the shared software domain resources may include one or more travel packages that include flight itineraries, hotel reservations, car rentals, restaurant reservations, or the like, which may be globally shared with all users associated with the service consumer persona type. Additionally, or alternatively, the shared software domain resources associated with the service provider user identity may be shared with one or more specific service consumer user identities (e.g., when providing a vehicle deal structure or financing offer for a specific service consumer user identity based on an estimated payment calculation or pre-qualification status indicated in a shared software domain resource associated with the service consumer user identity). For example, in some implementations, the tools, utilities, microservices, or other functions that are provided by or facilitated through the collaboration system may include one or more options to share the software domain resources with one or more service consumer user identities or with all service consumer user identities that are associated with the service consumer persona type. For example, a first service provider user identity (P1) may globally share a first software domain resource (R1) with all users associated with a service consumer persona type, whereby the sharing information associated with the first software domain resource may be represented as P1R1 (e.g., omitting any service consumer user identity to indicate that the software domain resource is globally shared). Similarly, a second software domain resource (R2) associated with the first service provider user identity may be shared with a second service consumer (C2) and an nth software domain resource (Rn) associated with the first service provider user identity may be shared with an nth service consumer (Cn), whereby the sharing information associated with n software domain resources associated with the first service provider user identity may be represented as [P1R1, P1R2C2, . . . , P1RnCn].

As further shown in FIG. 1A, and by reference number 125, the collaboration system may configure access to the software domain resources that are created through the collaboration system based on different persona types (e.g., service consumer and/or service provider persona types). For example, in some implementations, the collaboration system may store, in the resource repository, information associated with each software domain resource created by a user of a service consumer client device and each software domain resource created by a user of a service provider client device. For example, the information associated with each software domain resource may generally include an association between the software domain resource and the user identity associated with the software domain resource, where the user identity associated with the software domain resource may be associated with a persona type (e.g., a service consumer or service provider persona type). Furthermore, in some implementations, the information associated with each software domain resource may include an association between the software domain resource and one or more user identities that the software domain resource is shared with. For example, a software domain resource associated with a service consumer persona type may be shared with one or more service provider user identities associated with a service provider persona type, and a software domain resource associated with a service provider persona type may be shared with one or more service consumer user identities associated with a service consumer persona type. Furthermore, as describe herein, access to the shared software domain resources may include different resource aggregation levels for different user persona types. For example, a user associated with the consumer persona type may be permitted to access all globally shared software domain resources across all service provider user identities and to access all software domain resources that are shared with their service consumer user identity. Furthermore, a user associated with the service provider persona type may be permitted to access only software domain resources that have been specifically shared with their service provider user identities (e.g., a service provider may be blocked or restricted from accessing consumer-created software domain resources that are unshared and/or consumer-created software domain resources that are shared only with other service providers).

For example, referring to FIG. 1B, and to reference number 130, one or more users associated with a service consumer persona type (shown as Consumer 1 and Consumer 2) may access the collaboration system via a consumer interface, and one or more users associated with a service provider persona type (shown as Provider 1 and Provider 2) may access the collaboration system via a provider interface. Accordingly, each user that accesses the collaboration system may create one or more software domain resources that are associated with a respective user identity corresponding to the user that created the software domain resource, and may optionally share the one or more software domain resources with user identities associated with other persona types. Furthermore, as described herein, a resource aggregation level (e.g., global or specific) for a shared software domain resource may be based on the persona type associated with the user that created the software domain resource.

For example, as shown by reference number 130 in FIG. 1B, a first user associated with a consumer persona type (shown as Consumer 1) may be associated with a first service consumer user identity (C1) and may create a first software domain resource (A) that is shared with a first service provider user identity (P1). In addition, in the example illustrated in FIG. 1B, the first user associated with the consumer persona type may create a second software domain resource (B) and may share the second software domain resource with a second service provider user identity (P2). Furthermore, in the example illustrated in FIG. 1B, a second user associated with the consumer persona type (shown as Consumer 2) may be associated with a second service consumer user identity (C2) and may create a first software domain resource (C) that is shared with the second service provider user identity (P2). In addition, the second user associated with the consumer persona type may create a second software domain resource (D) that is unshared. Accordingly, in some implementations, the various software domain resources created by the users associated with the consumer persona type may be stored in the resource repository along with access control information that indicates the sharing status for each software domain resource (e.g., whether the software domain resource is shared or unshared, and which service providers have access to software domain resources that are shared).

As further shown by reference number 130 in FIG. 1B, a first user associated with a service provider persona type (shown as Provider 1) may be associated with a first service provider user identity (P1) and may create a first software domain resource (E) that is shared with a first service consumer user identity (C1). In addition, the first user associated with the service provider persona type may create a second software domain resource (F) and may share the second software domain resource with a second service consumer user identity (C2). Furthermore, in the example illustrated in FIG. 1B, a second user associated with the service provider persona type (shown as Provider 2) may be associated with a second service provider user identity (P2) and may create a first software domain resource (G) that is shared with the second service consumer user identity (C2) and a second software domain resource (H) that is unshared. Accordingly, in some implementations, the various software domain resources created by the users associated with the service provider persona type may be stored in the resource repository along with access control information that indicates the sharing status for each software domain resource (e.g., whether the software domain resource is shared with specific service consumer user identities and/or globally shared, and which service consumer user identities have access to which shared software domain resources).

As further shown in FIG. 1B, and by reference number 135, the collaboration system may store, in the resource repository, access control information that indicates which software domain resources are accessible to each user identity, which may be based on the persona type associated with the corresponding user identity. For example, in FIG. 1B, the access control information is shown as a Venn diagram, although any suitable representation may be used (e.g., an access control list or the like). For example, referring to FIG. 1B, the first user associated with the service consumer persona type (Consumer 1, associated with a first service consumer user identity) has access to software domain resources A and B that were created by Consumer 1, and to software domain resource E that was shared with Consumer 1 by the first user associated with the service provider persona type (Provider 1, associated with a first service provider user identity). As further shown, the second user associated with the service consumer persona type (Consumer 2, associated with a second service consumer user identity) has access to software domain resources C and D that were created by Consumer 2, to software domain resource F that was shared with Consumer 2 by Provider 1, and to software domain resource G that was shared with Consumer 2 by the second user associated with the service provider persona type (Provider 2, associated with a second service provider user identity). As further shown, Provider 1 has access to software domain resources E and F that were created by Provider 1 and to software domain resource A that was shared with Provider 1 by Consumer 1, and Provider 2 has access to software domain resources G and H that were created by Provider 2, software domain resource B that was shared with Provider 2 by Consumer 1, and software domain resource C that was shared with Provider 2 by Consumer 2. Accordingly, as described herein, each user that interacts with the collaboration system may generally have access to any software domain resources associated with their user identities, and to any software domain resources that users associated with other persona types have shared with their user identities. Furthermore, users associated with the service consumer persona type may have access to software domain resources that users associated with the service provider persona type may have access to any software domain resources that are created and globally shared by one or more service providers.

For example, FIG. 1C illustrates an example access protocol that may be used to control access to software domain resources available through the collaboration system based on a persona type of the requesting user and the access control information associated with the software domain resources. For example, as shown by reference number 140, the collaboration system may receive, from a client device, a request to access a software domain resource, where the request may include information related to the software domain resource and to a user identity and/or persona type of the user operating the client device (e.g., service consumer or service provider). As further shown in FIG. 1C, and by reference number 145, the collaboration system may provide, to the client device, a response that grants or rejects the request based on the persona type associated with the user of the client device and the user identity associated with the user of the client device. For example, in some implementations, the response may generally grant access to the software domain resource in cases where the software domain resource was created by the user of the client device. However, in cases where the request is to access a software domain resource created by a different user, the request may be granted or may be rejected depending upon the persona type of the user that created the software domain resource and the access control information associated with the software domain resource.

For example, reference number 150 in FIG. 1C corresponds to an example flow that may be performed by the collaboration system in response to a request to access a software domain resource associated with a service consumer user identity (C1). For example, in some implementations, the request to access the software domain resource associated with the service consumer user identity may indicate a user identity of the requesting user, and may indicate the software domain resource that the requesting user is requesting to access. As shown, the collaboration system may determine whether the requesting user is in a list of allowed clients associated with the software domain resource. For example, when the user associated with the service consumer user identity creates the software domain resource, the user may optionally share the software domain resource with one or more other users that are associated with respective user identities, which may define the allowed clients list. Furthermore, in some implementations, the allowed clients list may include the service consumer user identity associated with the user that created the software domain resource. Accordingly, in cases where the user requesting access to the software domain resource is not in the allowed clients list, the collaboration system may reject the request. Alternatively, in cases where the user requesting access to the software domain resource is in the allowed clients list, the collaboration system may perform an additional check to verify that the service consumer user identity is included in the request. As shown, the collaboration system may then reject the request in cases where the service consumer user identity is not included in the request, or may grant access to any software domain resource associated with the service consumer user identity in cases where the service consumer user identity is included in the request.

Additionally, or alternatively, reference number 155 in FIG. 1C corresponds to an example flow that may be performed by the collaboration system in response to a request to access a software domain resource associated with a service provider user identity (P1). For example, in some implementations, the collaboration system may determine whether the request includes a service provider user identity, and may reject the request in cases where the request does not include a service provider user identity. Alternatively, in cases where the request includes a service provider user identity, the collaboration system may determine whether the requesting user is attempting to access a set of software domain resources that spans multiple service providers. As shown, the collaboration system may then reject the request in cases where the requesting user is attempting to access a set of software domain resources that spans multiple service providers, or may grant access to any software domain resource associated with the service provider user identity in cases where the requesting user is not attempting to access a set of software domain resources that spans multiple service providers.

As indicated above, FIGS. 1A-1C are provided as an example. Other examples may differ from what is described with regard to FIGS. 1A-1C.

FIG. 2 is a diagram of an example environment 200 in which systems and/or methods described herein may be implemented. As shown in FIG. 2, environment 200 may include a consumer client device 210, a provider client device 220, a collaboration system 230, a resource repository 240, and a network 250. Devices of environment 200 may interconnect via wired connections, wireless connections, or a combination of wired and wireless connections.

The consumer client device 210 may include one or more devices capable of receiving, generating, storing, processing, and/or providing information associated with multi-persona resource access and collaboration with fine-grained access controls, as described elsewhere herein. The consumer client device 210 may include a communication device and/or a computing device. For example, the consumer client device 210 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The provider client device 220 may include one or more devices capable of receiving, generating, storing, processing, and/or providing information associated with multi-persona resource access and collaboration with fine-grained access controls, as described elsewhere herein. The provider client device 220 may include a communication device and/or a computing device. For example, the provider client device 220 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The collaboration system 230 may include one or more devices capable of receiving, generating, storing, processing, providing, and/or routing information associated with multi-persona resource access and collaboration with fine-grained access controls, as described elsewhere herein. The collaboration system 230 may include a communication device and/or a computing device. For example, the collaboration system 230 may include a server, such as an application server, a client server, a web server, a database server, a host server, a proxy server, a virtual server (e.g., executing on computing hardware), or a server in a cloud computing system. In some implementations, the collaboration system 230 may include computing hardware used in a cloud computing environment.

The resource repository 240 may include one or more devices capable of receiving, generating, storing, processing, and/or providing information associated with multi-persona resource access and collaboration with fine-grained access controls, as described elsewhere herein. The resource repository 240 may include a communication device and/or a computing device. For example, the resource repository 240 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the resource repository 240 may store access control information that indicates whether one or more service provider user identities associated with the provider client device 220 have permission to access a software domain resource created by a user associated with the consumer client device 210, as described elsewhere herein.

The network 250 may include one or more wired and/or wireless networks. For example, the network 250 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 250 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with multi-persona resource access and collaboration with fine-grained access controls. The device 300 may correspond to the consumer client device 210, the provider client device 220, the collaboration system 230, and/or the resource repository 240. In some implementations, the consumer client device 210, the provider client device 220, the collaboration system 230, and/or the resource repository 240 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

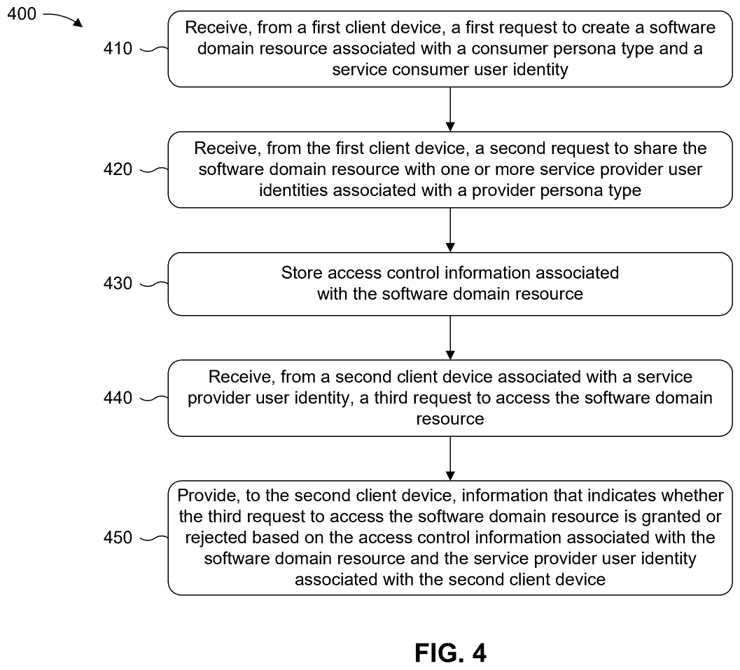

FIG. 4 is a flowchart of an example process 400 associated with multi-persona resource access and collaboration with fine-grained access controls. In some implementations, one or more process blocks of FIG. 4 may be performed by the collaboration system 230. In some implementations, one or more process blocks of FIG. 4 may be performed by another device or a group of devices separate from or including the collaboration system 230, such as the consumer client device 210, the provider client device 220, and/or the resource repository 240. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving, from a first client device, a first request to create a software domain resource associated with a consumer persona type and a service consumer user identity (block 410). For example, the collaboration system 230 (e.g., using processor 320, memory 330, input component 340, and/or communication component 360) may receive, from a first client device, a first request to create a software domain resource associated with a consumer persona type and a service consumer user identity, as described above in connection with reference number 105 of FIG. 1A. As an example, a user operating a consumer client device may be associated with a consumer persona type and may interact with the collaboration system to create a software domain resource that relates to an estimated payment calculation, a financing prequalification, or other information associated with a potential vehicle purchase or a potential vehicle lease. Furthermore, the user of the consumer client device may be associated with a service consumer user identity, which may be associated with the software domain resource created by the user operating the consumer client device.

As further shown in FIG. 4, process 400 may include receiving, from the first client device, a second request to share the software domain resource with one or more service provider user identities associated with a provider persona type (block 420). For example, the collaboration system 230 (e.g., using processor 320, memory 330, input component 340, and/or communication component 360) may receive, from the first client device, a second request to share the software domain resource with one or more service provider user identities associated with a provider persona type, as described above in connection with reference number 110 of FIG. 1A. As an example, the user operating the consumer client device may indicate one or more service provider user identities to have access to the software domain resource created by the user of the consumer client device, such as a vehicle dealer or financial institution that may offer vehicle sales services or vehicle financing services based on the estimated payment calculation, pre-qualification status, or other information associated with the shared software domain resource.

As further shown in FIG. 4, process 400 may include storing access control information associated with the software domain resource (block 430). In some implementations, the access control information indicates that the one or more service provider user identities associated with the second request have permission to access the software domain resource. For example, the collaboration system 230 (e.g., using processor 320 and/or memory 330) may store access control information associated with the software domain resource, wherein the access control information indicates that the one or more service provider user identities associated with the second request have permission to access the software domain resource, as described above in connection with reference number 125 of FIG. 1A and/or reference numbers 130 and 135 of FIG. 1B. As an example, the stored information may include any suitable representation of the software domain resource created by the user of the consumer client device, the service consumer user identity associated with user of the consumer client device, and the one or more service provider user identities that are permitted to access or otherwise interact with the software domain resource.

As further shown in FIG. 4, process 400 may include receiving, from a second client device associated with a service provider user identity, a third request to access the software domain resource (block 440). For example, the collaboration system 230 (e.g., using processor 320, memory 330, input component 340, and/or communication component 360) may receive, from a second client device associated with a service provider user identity, a third request to access the software domain resource, as described above in connection with reference numbers 140 and 155 of FIG. 1C. As an example, a vehicle dealer or financial institution may be associated with a service provider user identity, and a user associated with the vehicle dealer or financial institution may operate a provider client device to request access to software domain resources shared with the service provider user identity of the vehicle dealer or financial institution (e.g., for estimated payment calculations or pre-qualification information that the user of the consumer client device has shared with the service provider user identity of the vehicle dealer or financial institution).

As further shown in FIG. 4, process 400 may include providing, to the second client device, information that indicates whether the third request to access the software domain resource is granted or rejected based on the access control information associated with the software domain resource and the service provider user identity associated with the second client device (block 450). For example, the collaboration system 230 (e.g., using processor 320 and/or memory 330) may provide, to the second client device, information that indicates whether the third request to access the software domain resource is granted or rejected based on the access control information associated with the software domain resource and the service provider user identity associated with the second client device, as described above in connection with reference numbers 145 and 155 of FIG. 1C. As an example, the information provided to the client device associated with the service provider may grant access to the shared software domain resource based on the sharing information associated with the software domain resource indicating that the user of the consumer client device has shared the software domain resource with the service provider user identity of the service provider client device. Additionally, or alternatively, the information provided to the client device associated with the service provider may deny access to the shared software domain resource based on the sharing information associated with the software domain resource indicating that the software domain resource has not been shared with the service provider user identity of the service provider client device.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for multi-persona resource access and collaboration, the system comprising:
one or more memories; and
one or more processors, communicatively coupled to the one or more memories, configured to:
receive, from a first client device, a first request to create a software domain resource associated with a consumer persona type and a service consumer user identity;
receive, from the first client device, a second request to share the software domain resource with one or more service provider user identities associated with a provider persona type;
store access control information associated with the software domain resource,
wherein the access control information indicates that the one or more service provider user identities associated with the second request have permission to access the software domain resource;
receive, from a second client device associated with a service provider user identity, a third request to access the software domain resource; and
provide, to the second client device, information that indicates whether the third request to access the software domain resource is granted or rejected based on the access control information associated with the software domain resource and the service provider user identity associated with the second client device.

2. The system of claim 1, wherein the information provided to the second client device indicates that the third request to access the software domain resource is granted based on the access control information indicating that the service provider user identity associated with the second client device is included among the one or more service provider user identities that have permission to access the software domain resource.

3. The system of claim 2, wherein the information provided to the second client device indicates that the third request to access the software domain resource is granted further based on the third request including an attempt to access a set of software domain resources that is associated only with the service provider user identity associated with the second client device.

4. The system of claim 1, wherein the information provided to the second client device indicates that the third request to access the software domain resource is rejected based on the access control information indicating that the service provider user identity associated with the second client device is not included among the one or more service provider user identities that have permission to access the software domain resource.

5. The system of claim 1, wherein the information provided to the second client device indicates that the third request to access the software domain resource is rejected based on the third request including an attempt to access a set of software domain resources associated with multiple service provider user identities.

6. The system of claim 1, wherein the one or more processors are further configured to:
receive, from one or more client devices associated with a provider persona type, information to create one or more software domain resources associated with the provider persona type,
wherein the one or more software domain resources are each associated with access control information that indicates one or more service consumer user identities that have permission to access the software domain resource;
receive, from the first client device, a fourth request to access software domain resources that are associated with the service consumer user identity of the first client device; and
provide, to the first client device, information that indicates whether the fourth request is granted or rejected based on the access control information associated with the one or more software domain resources associated with the provider persona type.

7. The system of claim 6, wherein the information provided to the first client device indicates that the fourth request is granted based on the access control information associated with the one or more software domain resources associated with the provider persona type indicating that the service consumer user identity associated with the first client device is included among the one or more service consumer user identities that have permission to access the software domain resource.

8. The system of claim 6, wherein the information provided to the first client device indicates that the fourth request is rejected based on the access control information associated with the one or more software domain resources associated with the provider persona type indicating that the service consumer user identity associated with the first client device is not included among the one or more service consumer user identities that have permission to access the software domain resource.

9. A method for multi-persona resource access and collaboration, comprising:
receiving, by a collaboration system and from a first client device, a first request to create a software domain resource associated with a consumer persona type and a service consumer user identity,
wherein the software domain resource is associated with access control information that indicates one or more service provider user identities, associated with a provider persona type, that have permission to access the software domain resource;
receiving, by a collaboration system and from a second client device associated with a service provider user identity, a second request to access the software domain resource; and
providing, by the collaboration system and to the second client device, information that indicates whether the second request to access the software domain resource is granted or rejected based on the access control information associated with the software domain resource and the service provider user identity associated with the second client device.

10. The method of claim 9, wherein the information provided to the second client device indicates that the second request to access the software domain resource is granted based on the access control information indicating that the service provider user identity associated with the second client device is included among the one or more service provider user identities that have permission to access the software domain resource.

11. The method of claim 10, wherein the information provided to the second client device indicates that the second request to access the software domain resource is granted further based on the second request including an attempt to access a set of software domain resources that is associated only with the service provider user identity associated with the second client device.

12. The method of claim 9, wherein the information provided to the second client device indicates that the second request to access the software domain resource is rejected based on the access control information indicating that the service provider user identity associated with the second client device is not included among the one or more service provider user identities that have permission to access the software domain resource.

13. The method of claim 9, wherein the information provided to the second client device indicates that the second request to access the software domain resource is rejected based on the second request including an attempt to access a set of software domain resources associated with multiple service provider user identities.

14. The method of claim 9, further comprising:
receiving, from one or more client devices associated with a provider persona type, information to create one or more software domain resources associated with the provider persona type,
wherein the one or more software domain resources are each associated with access control information that indicates one or more service consumer user identities that have permission to access the software domain resource;
receiving, from the first client device, a third request to access software domain resources that are associated with the service consumer user identity of the first client device; and
providing, to the first client device, information that indicates whether the third request is granted or rejected based on the access control information associated with the one or more software domain resources associated with the provider persona type.

15. The method of claim 14, wherein the information provided to the first client device indicates that the third request is granted based on the access control information associated with the one or more software domain resources associated with the provider persona type indicating that the service consumer user identity associated with the first client device is included among the one or more service consumer user identities that have permission to access the software domain resource.

16. The method of claim 14, wherein the information provided to the first client device indicates that the third request is rejected based on the access control information associated with the one or more software domain resources associated with the provider persona type indicating that the service consumer user identity associated with the first client device is not included among the one or more service consumer user identities that have permission to access the software domain resource.

17. A non-transitory computer-readable medium storing a set of instructions, the set of instructions comprising:
one or more instructions that, when executed by one or more processors of a collaboration system, cause the collaboration system to:
receive, from a first client device, a first request to create a software domain resource associated with a consumer persona type and a service consumer user identity;
receive, from the first client device, a second request to share the software domain resource with one or more service provider user identities associated with a provider persona type;
store access control information associated with the software domain resource,
wherein the access control information indicates that the one or more service provider user identities associated with the second request have permission to access the software domain resource;
receive, from a second client device associated with a service provider user identity, a third request to access the software domain resource; and
provide, to the second client device, information that indicates whether the third request to access the software domain resource is granted or rejected based on the access control information associated with the software domain resource and the service provider user identity associated with the second client device.

18. The non-transitory computer-readable medium of claim 17, wherein the information provided to the second client device indicates that the third request to access the software domain resource is granted based on the access control information indicating that the service provider user identity associated with the second client device is included among the one or more service provider user identities that have permission to access the software domain resource.

19. The non-transitory computer-readable medium of claim 18, wherein the information provided to the second client device indicates that the third request to access the software domain resource is granted further based on the third request including an attempt to access a set of software domain resources that is associated only with the service provider user identity associated with the second client device.

20. The non-transitory computer-readable medium of claim 17, wherein the information provided to the second client device indicates that the third request to access the software domain resource is rejected based on one or more of:
the access control information indicating that the service provider user identity associated with the second client device is not included among the one or more service provider user identities that have permission to access the software domain resource, or
the third request including an attempt to access a set of software domain resources associated with multiple service provider user identities.
